(19) United States
(12) Patent Application Publication
(10) Pub. No.: US 2025/0063397 A1
(43) Pub. Date: Feb. 20, 2025

(54) METHOD TO TRIGGER PROTOCOL DATA UNIT LOOP BACKING IN CONFORMANCE TESTING

(71) Applicant: Nokia Technologies Oy, Espoo (FI)

(72) Inventors: Rachit MAHENDRA, Khairabad (IN); Matti Juhani KANGAS, Oulu (FI); Tuomo Mikael SÄYNÄJÄKANGAS, Oulu (FI); Bent Henneberg RYSGAARD, Aalborg (DK)

(21) Appl. No.: 18/805,027

(22) Filed: Aug. 14, 2024

(30) Foreign Application Priority Data
Aug. 18, 2023 (IN) 202341055559

(51) Int. Cl. H04W 24/06; H04W 24/04

(52) U.S. Cl. CPC H04W 24/06; H04W 24/04

(57) ABSTRACT

Embodiments of the present disclosure relate to apparatuses, methods, devices and computer readable storage medium to trigger loop backing of protocol data units (PDUs) in conformance testing. The method comprising: at a first apparatus, the first apparatus receives, from a second apparatus, a configuration of a test loop mode for the first apparatus at least indicating one or more timers for delaying a plurality of PDUs buffered in the first apparatus and the number of PDUs to be looped back in a test loop from the first apparatus to the second apparatus at an expire of each of the one or more timers; and the first apparatus participates in a conformance test at least based on the configuration.

### FIELDS

Various example embodiments of the present disclosure generally relate to the field of telecommunication and in particular, to methods, devices, apparatuses and computer readable storage medium to trigger protocol data unit (PDU) loop backing in conformance testing.

### BACKGROUND

To support 5th generation system (5GS) conformance testing, user equipment (UE) special conformance test functions are required. A part of the core requirements is formed and there is a direct impact on the design of the UE. The UE special conformance test functions vary depending on the conformance testing functionality. Thus, they are designed to support and are broadly classified into two groups.

One group is related to test loop functions which require a loop to be established between the UE and the System Simulator (SS) to allow, e.g., downlink (DL) data packets sent by the SS to be looped back to uplink (UL) by the UE. The other group is related to general test functions with which commands are sent by the SS, e.g., to trigger a certain UE behavior which may be a behavior determined by the 3rd Generation Partnership Project (3GPP) core specification requirements or such needed to facilitate conformance testing and not being part of any 3GPP core specification requirements, or, to provide to the UE information needed for the conformance testing.

### SUMMARY

In a first aspect of the present disclosure, there is provided a first apparatus. The first apparatus comprises at least one processor; and at least one memory storing instructions that, when executed by the at least one processor, cause the first apparatus at least to: receive, from a second apparatus, a configuration of a test loop mode for the first apparatus at least indicating one or more timers for delaying a plurality of PDUs buffered in the first apparatus and the number of PDUs to be looped back in a test loop from the first apparatus to the second apparatus at an expire of each of the one or more timers; and participate in a conformance test at least based on the configuration.

In a second aspect of the present disclosure, there is provided a second apparatus. The second apparatus comprises at least one processor; and at least one memory storing instructions that, when executed by the at least one processor, cause the second apparatus at least to: transmit, to a first apparatus, a configuration of a test loop mode for the first apparatus at least indicating one or more timers for delaying a plurality of PDUs, buffered in the first apparatus and the number of PDUs to be looped back in a test loop from the first apparatus to the second apparatus at an expire of each of the one or more timers.

In a third aspect of the present disclosure, there is provided a method. The method comprises: receiving, from a second apparatus, a configuration of a test loop mode for the first apparatus at least indicating one or more timers for delaying a plurality of PDUs, buffered in the first apparatus and the number of PDUs to be looped back in a test loop from the first apparatus to the second apparatus at an expire of each of the one or more timers; and participating in a conformance test at least based on the configuration.

In a fourth aspect of the present disclosure, there is provided a method. The method comprises: transmitting, to a first apparatus, a configuration of a test loop mode for the first apparatus at least indicating one or more timers for delaying a plurality of PDUs, buffered in the first apparatus and the number of PDUs to be looped back in a test loop from the first apparatus to the second apparatus at an expire of each of the one or more timers.

In a fifth aspect of the present disclosure, there is provided a first apparatus. The first apparatus comprises means for receiving, from a second apparatus, a configuration of a test loop mode for the first apparatus at least indicating one or more timers for delaying a plurality of PDUs, buffered in the first apparatus and the number of PDUs to be looped back in a test loop from the first apparatus to the second apparatus at an expire of each of the one or more timers; and means for participating in a conformance test at least based on the configuration.

In a sixth aspect of the present disclosure, there is provided a second apparatus. The second apparatus comprises means for transmitting, to a first apparatus, a configuration of a test loop mode for the first apparatus at least indicating one or more timers for delaying a plurality of PDUs, buffered in the first apparatus and the number of PDUs to be looped back in a test loop from the first apparatus to the second apparatus at an expire of each of the one or more timers.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example signaling chart to trigger PDU loop backing in conformance testing according to some example embodiments of the present disclosure;

FIG. 3 illustrates an example of timers configured with an independent way according to some example embodiments of the present disclosure;

FIG. 4 illustrates an example of timers configured with a dependent way according to some example embodiments of the present disclosure;

FIG. 5 illustrates a flowchart of a method implemented at a first device according to some example embodiments of the present disclosure;

FIG. 6 illustrates a flowchart of a method implemented at a second device according to some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node. In the present disclosure, the “network device” may also refer to a test equipment (TE) or a system simulator (SS).

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

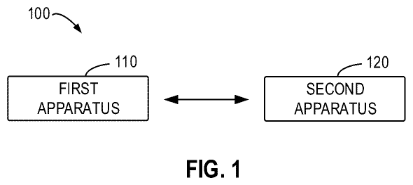

FIG. 1 illustrates an example communication environment 100 in which example embodiments of the present disclosure may be implemented. As shown in FIG. 1, the communication environment 100 may include a first apparatus 110 and a second apparatus 120. The first apparatus 110 may communicate with the second apparatus 120.

In some example embodiments, the first apparatus 110 may comprise a device under test (DUT) or a terminal device (e.g., UE), and the second apparatus 120 may comprise a test equipment (TE) or a system simulator (SS).

It is to be understood that the number of first apparatus 110 and second apparatus 120 shown in FIG. 1 is given for the purpose of illustration without suggesting any limitations. The communication environment 100 may include any suitable number of first apparatus 110 and second apparatus 120.

In the following, for the purpose of illustration, some example embodiments are described with the first apparatus 110 operating as a DUT and the second apparatus 120 operating as TE or SS. However, in some example embodiments, operations described in connection with a DUT may be implemented at a terminal device, and operations described in connection with a TE or SS may be implemented at other simulating device.

In some example embodiments, a link from a network device to a terminal device is referred to as a downlink (DL), and a link from a terminal device to a network device is referred to as an uplink (UL). In DL, the network device is a transmitting (TX) device (or a transmitter) and the terminal device is a receiving (RX) device (or a receiver). In UL, the terminal device is a TX device (or a transmitter) and the network device is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

The utilization of any UE special conformance test functions shall be considered as putting the UE in a test mode. The duration of the test mode depends on the UE special conformance test function and in most of the cases will be delimited by an activation and a deactivation command. The UE special conformance test functions including any relevant procedure and the Test Mode Control (TMC) message contents used for information exchange have already defined.

The UE special conformance test functions provide access to isolated functions of the UE via the radio interface without introducing new physical interfaces just for the reason of conformance testing. However, in certain cases the usage of AT Commands may be required which will require an external interface, e.g., Extended Mobility Management Interface (EMMI).

Depending on the conformance testing functionality supported, the UE special conformance test functions may comprise a single DL message (e.g., a test function intended to provide to the UE information needed for the conformance testing).

The UE special conformance test functions may also comprise a Request/Acknowledgement type of 2 messages exchange, an DL message followed by a UL message, (e.g., a test function intended to request the UE to execute an action which requires acknowledgment that request was received and acted upon).

The UE special conformance test functions may also comprise two or more UE special conformance test functions which may be needed to be executed in a particular sequence before a specific target UE behavior can be assumed. An example for this is the Activate UE test mode and Close UE test loop functions. The former needs to be executed first, at a particular moment of time, in order a specific type of test bearer terminated in a particular UE protocol layer to be established. Followed by the latter, executed at different point of time, which will instruct the UE to start looping back the received packets.

While testing devices, the best is to test the device as a black box and the most common use case is having the device connected to a network simulator via the air interface only. However, it is not possible in all use cases. For example, when testing data transfer, it is important for the network simulator to have control of what the device is sending. For example, for the UL data, it is unknown what source is there within the device to send a specific test data set.

For such a case, specific Over the Air Test commands (OTA TST commands) are used. The test commands have their own protocol discriminator/protocol end point, a protocol running in parallel to other protocols at layer 3 (L3) level, like Radio Resource Control (RRC), Mobility Management (MM), etc.

One set of commands is for loop back of data, meaning the network simulator sends data towards the device and the device is configured to send the same frames back in the uplink. The mapping between downlink and uplink and at which protocol layers can be configured. For example, the UE in RRC_Connected state receives a Close UE Test Loop message from the SS and transmits a Close UE Test Loop Complete message to the SS.

Another way to control the device may be via Mobile Terminal/Terminal Equipment (MT/TE) communication. This requires a physical interface separate to the 3GPP air interface which allows the exchange of AT commands. In this way, it is possible to command and control test procedures in the device. An example is for Vehicle-to-Everything (V2X) testing.

Small data transmission (SDT) has been introduced in 3GPP for 5G NR, where small packets of data can be transmitted while the UE is in RRC INACTIVE state. This feature in intended as an energy saving feature, since the UE can stay longer periods of time in RRC INACTIVE state. There are two main different implementations of SDT, in one the UE transmits small transport blocks as part of the Random Access (RA) procedure while in RRC INACTIVE state, while in the other one a Configured Grant (CG) resource is allocated for the UE to transmit in RRC INACTIVE state. The last type of SDT transmission is referred to in this text as CG-SDT.

For the CG-SDT to function properly, there is a mechanism for the UE to keep synchronicity in UL. While in RRC CONNECTED state, the gNB can align the UL transmissions though a Timing Advance (TA) Command (TAC). However, when the UE is moved to RRC INACTIVE state, there are no means for the gNB to keep this message exchange and keep the UL transmissions synchronous to the UL resources. Therefore, a TA validation mechanism is defined as being responsible to detect if the UE has moved. It is done by detecting changes in received signal levels and define a range in receive levels, where a level outside the range will indicate a too large change in propagation delay, which is the base for the timing advance used between the network and the UE.

The TA validation works as follows: two Reference Signal Received Power (RSRP) values are collected, namely RSRP1 is collected next to the time when the TAC is received by the UE and RSRP2 is collected when the TA validation is performed for transmitting in a CG-SDT occasion.

While the UE is still in RRC CONNECTED state, when the UE receives the reference TAC command at time T1, it should perform an RSRP measurement, RSRP1 at time T1′. This measurement, RSRP1, may be considered valid for the purpose of CG-SDT only if |T1−T1′|<W1, where W1 is the time window within the first RSRP value should be collected.

The UE enters RRC INACTIVE state when it receives an RRC Release with a Suspend Config message from the gNB or TE, and it may thereafter use SDT resources for UL-SDT if this message includes the SDT configuration. For the UE to transmit in a CG-SDT resource, it must measure RSRP2 at time T2′, so that it can make the decision to transmit on CG-SDT at time T2, where T2−W2<T2′<T2, and W2 is the window where the RSRP2 measurement must be performed.

Additionally, it has been decided that T3−T2<=1060 ms (for FR2) and 860 ms (for FR1), where T3 is the time of the transmission on the CG-SDT resource and T2 is defined above. The UE may transmit on the CG-SDT occasion if it has valid RSRP1 and RSRP2 measurements (performed within W1 and W2 respectively) and if |RSRP1−RSRP2|<cg-SDT-RSRP-ChangeThreshold. If so, the UE may regard the TA to be valid for the network to be able to receive a UL transmission from the UE on CG-SDT resources.

Once the UE meets these requirements, it should be able to transmit with small UL timing error on a CG-SDT occasion. This transmission also has requirements for the timing accuracy.

The work for SDT test cases (for both RA-SDT and CG-SDT) is being done under the work item titled ‘WP UE Conformance-NR small data transmissions in INACTIVE state’ having work item code ‘NR_SmallData_INACTIVE-UEConTest’.

Under this work item, there are several CG-SDT test cases. For example, these test cases comprise Data on non-SDT radio bearers, TA Validation for CG-SDT in NR Stand Alone (SA) frequency range 2 (FR2), and NR Stand Alone (SA) frequency range 1 (FR1).

The above test cases at least require the loop backing of more than 1 Service Data Adaptation Protocol (SDAP) PDUs in the uplink while the UE is in RRC INACTIVE state. The detailed test procedure for the above-mentioned test cases is still under discussion and will be further discussed.

Based on the above analysis, there may be several problems to be solved.

Particularly, in the CG-SDT test case titled ‘Data on non-SDT radio bearers’, the test requires that the data on non-SDT radio bearers arrives when CG-SDT is ongoing.

The corresponding test procedure defined using the existing ‘UE Test Loop Mode B’ is given as below:

TABLE 1

| | | Message Sequence | | | |
|---|---|---|---|---|---|
| St | Procedure | U - S | Message | TP | Verdict |
| 1 | The SS transmits a CLOSE UE TEST LOOP | <-- | NR RRC: | — | — |
| | message with UE test loop mode B selected | | DLInformationTransfer | | |
| | and T_delay_modeB timer configured. | | TC: CLOSE UE TEST | | |
| | | | LOOP | | |
| 2 | The UE transmits a CLOSE UE TEST | --> | NR RRC: | — | — |
| | LOOP COMPLETE message. | | ULInformationTransfer | | |
| | | | TC: CLOSE UE TEST | | |
| | | | LOOP COMPLETE | | |
| 3 | The SS sends 1st SDAP Data PDU to the UE | <-- | SDAP DL Data PDU | — | — |
| | with SDAP header contents RDI = 1. RQI = 0, | | | | |
| | QFI = 1 on DRB j (DRB j is included in sdt- | | | | |
| | DRB-List-r17). The IP Packet is less than | | | | |
| | sdt-Data VolumeThreshold. (Note 1) | | | | |
| 4 | The UE buffers the received 1^{st} SDAP SDU | — | — | — | — |
| | (IP PDU) and waits for T_delay_modeB | | | | |
| | timer to expire. | | | | |
| 5 | The SS sends 2^{nd} SDAP Data PDU to the | <-- | SDAP DL Data PDU | — | — |
| | UE with SDAP header contents RDI = 1. | | | | |
| | RQI = 0, QFI = 2 on DRB k (DRB k is not | | | | |
| | included in sdt-DRB-List-r17). The IP | | | | |
| | Packet is less than sdt- | | | | |
| | DataVolumeThreshold. (Note 1) | | | | |
| 6 | The UE buffers the received 2^{nd} SDAP SDU | — | — | — | — |
| | (IP PDU) and waits for T_delay_modeB | | | | |
| | timer to expire. | | | | |
| 7 | The SS transmits an RRCRelease message | <-- | NR RRC: RRCRelease | — | — |
| | with suspendConfig which includes SDT- | | | | |
| | CG-Config-r17 and sdt-DRB-List-r17 IEs. | | | | |
| | The only DRBs in sdt-DRB-List-r17 are | | | | |
| | enabled for SDT (DRB j). | | | | |
| 8 | After some time when T_delay_modeB timer | — | — | — | — |
| | expires, buffered IP PDUs are submitted in | | | | |
| | the same order as received (first-in-first-out) | | | | |
| | and without any modification of the IP | | | | |
| | header to the UL QoS flow descriptions | | | | |
| | handling SAP for transmission in uplink. | | | | |
| 9 | As the 1^{st} SDAP PDU was received (in Step | --> | NR RRC: | | |
| | 4) on DRB j (SDT enabled DRB) with | | RRCResumeRequest | | |
| | Reflective QoS flow to DRB mapping, the | | | | |
| | 1^{st} looped back SDAP SDU is mapped to | | | | |
| | DRB j with QFI = 1. UE transmit an | | | | |
| | RRCResumeRequest and the looped back | | | | |
| | SDAP SDU received in step 4 in a CG | | | | |
| | PUSCH occasion. | | | | |
| 10 | As the 2^{nd} SDAP PDU was received (in Step | — | — | — | — |
| | 6) on DRB k (non-SDT DRB) with | | | | |
| | Reflective QoS flow to DRB mapping, the | | | | |
| | 2^{nd} looped back SDAP SDU is mapped to | | | | |
| | DRB k with QFI = 2. Therefore, data | | | | |
| | appears on a non-SDT DRB. | | | | |
| 11 | Check: Does the UE transmit an | --> | NR RRC: | 1 | P |
| | UEAssistanceInformation message | | UEAssistanceInformation | | |
| | containing nonSDT-DataIndication-r17 IE | | | | |
| | including resume Cause-r17? | | | | |

(Note 1):
RLC PDU for IP packet is 97 bytes (RLC SDU is 94 bytes for 3 bytes RLC header and 95 bytes for 2 bytes RLC header) and sdt-Data VolumeThreshold is 100 bytes. Therefore, the size of RLC SDU is less than the sdt-Data VolumeThreshold.

The problem with the above test procedure is that both of the SDAP SDUs received and buffered by the DUT (in steps 4 and 6) will be pushed/sent by the loopback entity to the DUT lower layers in the same order as received, i.e., first input first output (FIFO), once T_delay_modeB timer expires (see step 8). Hence, there is no existing mechanism to independently control the delay of buffered 2nd SDAP SDU as it will be pushed immediately after the 1^{st} buffered SDAP PDU is pushed (in FIFO order). Therefore, in steps 9 and 10 of the above test procedure, it cannot guarantee that the RRCResumeRequest is already sent before the 2^{nd} SDAP SDU is loop backed. This implies that non-SDT data arrives during the test without ensuring that CG-SDT is ongoing, which leads to inconclusive UE behavior due to the unavailability of independent delay timers for different internet protocol (IP) PDUs.

Furthermore, the time between two consecutive SDT sessions will be same, i.e., if t1, t2, t3 and t4 are the times when a CG-SDT session needs to be initiated (as data is loop backed), then repetition-based method will constrain t1, t2, t3 and t4 to be t2−t1=t3−t2=t4−t3=T, which has less flexibility in selecting the transmission time. Hence, for the case where data needs to be loop backed at unequal times, i.e., where t2−t1≠t3−t2≠t4−t3, the OTA approach-based solution is still not known.

Last but not the least, the granularity of T_delay_modeB timer of existing UE Test Loop Mode B is in seconds which means that currently it is not possible to configure an IP PDU delay time which is not a positive integer (configuring IP PDU delay time in milliseconds in currently not possible).

According to some example embodiments of the present disclosure, there is provided a solution to trigger PDU loop backing in conformance testing. According to various example embodiments of the present disclosure, a first apparatus 110 receives a configuration of a test loop mode from a second apparatus 120. The configuration for the first apparatus 110 at least indicates one or more timers for delaying a plurality of PDUs buffered in the first apparatus 110 and corresponding number of PDUs to be looped back in a test loop from the first apparatus 110 to the second apparatus 120 at an expire of each of the one or more timers. Further, the first apparatus 110 participates in the conformance test at least based on the configuration.

In this way, multiple IP PDU delay timers are configured and therefore loopback of different data PDUs received on different DRBs with individual delay timer value can be allowed.

Example embodiments of the present disclosure will be described in detail below with reference to the accompanying drawings.

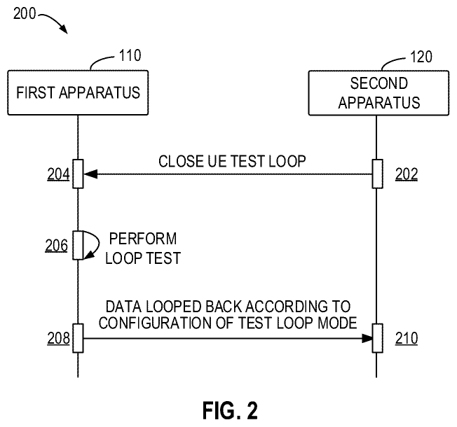

Reference is now made to FIG. 2, which illustrates an example signaling chart 200 to trigger PDU loop backing in conformance testing according to some example embodiments of the present disclosure. As shown in FIG. 2, the signaling chart 200 involves the first apparatus 110 and the second apparatus 120. For the purposes of discussion, the signaling chart 200 will be discussed with reference to FIG. 1, for example, by using the first apparatus 110 (e.g., a DUT) and the second apparatus 120 (e.g., a TE/SS).

The second apparatus 120 may transmit (202), to the first apparatus 110, a configuration of a test loop mode of the first apparatus 110. For example, the second apparatus 120 may transmit the configuration of a test loop mode to the first apparatus 110 via a Close UE Test Loop message. Correspondingly, the first apparatus 110 may receive (204) the configuration of a test loop mode via the Close UE Test Loop message.

In some embodiments, the configuration may indicate one or more timers for delaying a plurality of the PDUs buffered in the first apparatus 110. Furthermore, the configuration may further indicate the number of configured timers and the number of PDUs to be looped back from the first apparatus 110 to the second apparatus 120 at an expire of each of the one or more configured timers.

Additionally or optionally, the configuration may further indicate the number of buffered PDUs to be flushed at the expiry of each of the one or more timers in a FIFO fashion, or a link between respective one or more PDUs and the one or more timers.

As an option, the one or more timers can be configured with an independent way. That is, the one or more timers may be configured with a same start time point but with different durations.

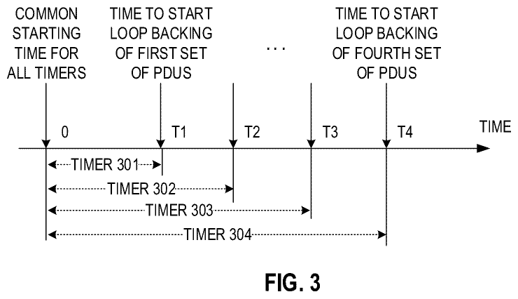

As shown in FIG. 3, which illustrates an example of timers configured with an independent way according to some example embodiments of the present disclosure, the starting time points of all the timers 301, 302, 303, and 304 are the same and durations of the timers 301, 302, 303, and 304 are different.

Due to the common starting time for all the timers, T1=a duration of timer 301, T2=a duration of timer 302, T3=a duration of timer 303, T4=a duration of timer 304.

As another option, the one or more timers can be configured with a dependent way. That is, the one or more timers may be configured with different start time points. A start time point of a subsequent timer in the one or more timers is relative to an expiry time of its previous timer in the one or more timers.

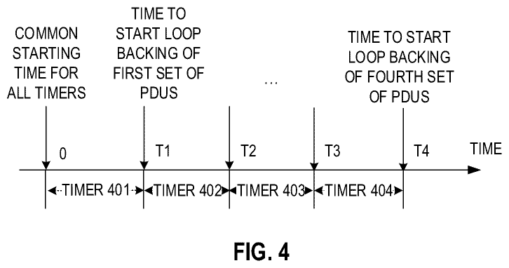

As shown in FIG. 4, which illustrates an example of timers configured with a dependent way according to some example embodiments of the present disclosure, starting time points of all the timers 401, 402, 403 and 404 are different but each may be relative to the expiry time of its previous timer. For example, timer 402 starts when timer 401 expires/stops. Similarly, n^{th} timer starts when (n−1)^{th} timer expires/stops.

Therefore, T1=a duration of timer 401, T2=a duration of timer 401+a duration of timer 402, T3=a duration of timer 401+a duration of timer 402+a duration of timer 403, T4=a duration of timer 401+a duration of timer 402+a duration of timer 403+a duration of timer 404, and so on.

In some embodiments, the configuration may be associated with a specific UE test loop mode, which may be indicated by an information element (IE) in the Close UE Test Loop message.

An example of the CLOSE UE TEST LOOP message, the proposed IEs and corresponding explanations are shown as in Table 2 and Table 3 below:

TABLE 2
CLOSE UE TEST LOOP message

| Information Element | Reference | Presence | Format | Length |
|---|---|---|---|---|
| Protocol discriminator | TS 24.007 [5], sub | M | V | ½ |
| | clause 11.2.3.1.1 | | | |
| Skip indicator | TS 24.007 [5], sub | M | V | ½ |
| | clause 11.2.3.1.2 | | | |
| Message type | | M | V | 1 |
| UE test loop mode | | M | V | 1 |
| UE test loop mode A LB setup | | CV-ModeA | LV | 1-25 |
| UE test loop mode B LB setup | | CV-ModeB | V | 1 |
| UE test loop mode C setup | | CV-ModeC | V | 3 |
| UE test loop mode D setup | | CV-ModeD | LV-E | 3-803 |
| UE test loop mode E setup | | CV-ModeE | LV | 2-18 |
| UE test loop mode F setup | | CV-ModeF | V | 2 |
| UE test loop mode GH setup | | CV-ModeGH | V | 2 |
| UE test loop mode X setup | | CV-ModeX | V | y |

TABLE 3
Condition and Explanation

| Condition | Explanation |
|---|---|
| CV-ModeA | This IE is mandatory present if the IE “UE test loop mode” is set to |
| | UE test loop Mode A. Else it shall be absent. |
| CV-ModeB | This IE is mandatory present if the IE “UE test loop mode” is set to |
| | UE test loop Mode B. Else it shall be absent. |
| CV-ModeC | This IE is mandatory present if the IE “UE test loop mode” is set to |
| | UE test loop Mode C. Else it shall be absent. |
| CV-ModeD | This IE is mandatory present if the IE “UE test loop mode” is set to |
| | UE test loop Mode D. Else it shall be absent. |
| CV-ModeE | This IE is mandatory present if the IE “UE test loop mode” is set to |
| | UE test loop Mode E. Else it shall be absent. |
| CV-ModeF | This IE is mandatory present if the IE “UE test loop mode” is set to |
| | UE test loop Mode F. Else it shall be absent. |
| CV-ModeGH | This IE is mandatory present if the IE “UE test loop mode” is set to |
| | UE test loop Mode G or UE test loop mode H. Else it shall be |
| | absent. |
| CV-ModeX | This IE is mandatory present if the IE “UE test loop mode” is |
| | set to UE test loop Mode X. Else it shall be absent. |

where message type is:

| | | | | | | | | |
|---|---|---|---|---|---|---|---|---|
| 8 | 7 | 6 | 5 | 4 | 3 | 2 | 1 | bit no. |
| 1 | 0 | 0 | 0 | 0 | 0 | 0 | 0 | octet 1 |

where UE test loop mode is:

| | | | | | | | | |
|---|---|---|---|---|---|---|---|---|
| 8 | 7 | 6 | 5 | 4 | 3 | 2 | 1 | bit no. |
| 0 | 0 | 0 | 0 | X4 | X3 | X2 | X1 | octet 1 |

X4=0 and X3=0 and X2=0 and X1=0 then UE test loop mode A is selected.
X4=0 and X3=0 and X2=0 and X1=1 then UE test loop mode B is selected.
X4=0 and X3=0 and X2=1 and X1=0 then UE test loop mode C is selected.
X4=0 and X3=0 and X2=1 and X1=1 then UE test loop mode D is selected.
X4=0 and X3=1 and X2=0 and X1=0 then UE test loop mode E is selected.
X4=0 and X3=1 and X2=0 and X1=1 then UE test loop mode F is selected.
X4=0 and X3=1 and X2=1 and X1=0 then UE test loop mode G is selected.
X4=0 and X3=1 and X2=1 and X1=1 then UE test loop mode H is selected.
X4=1 and X3=0 and X2=0 and X1=0 then UE test loop mode I is selected.
X4=a and X3=b and X2=c and X1=d then UE test loop mode X is selected.

It is noted that the values ‘a b c d’ in X4=a and X3=b and X2=c and X1=d to be specified with any suitable values.

Other combinations of X1 and X2 and X3 and X4 are reserved for future versions of the protocol.

As shown in Table 2, the existing information elements include such as UE test loop mode A LB setup, UE test loop mode B LB setup, UE test loop mode C setup . . . UE test loop mode GH setup. According to the example embodiments of the present disclosure, UE test loop mode X setup (with an underline) is proposed. It is to be understood that X is only used for differentiation purposes and X could be replaced with other letters. For clarity, the newly content will be marked with an underline herein.

For the newly introduced information element ‘UE test loop mode X setup’ which needs to be added to the existing CLOSE UE TEST LOOP information element, as described above, the second apparatus may further indicate the configuration of one or more timers such as the number of different timers to be configured, the number of buffered IP PDUs to be flushed at the expiry of each timer in a FIFO fashion, and the delay value for each timer to be configured.

An example for the newly introduced UE test loop mode X setup is show as below:

TABLE 4

| | |
|---|---|
| 8 7 6 5 4 3 2 1 | |
| Number of timers to be configured, N | Octet 1 |
| IP PDU delay for 1^{st} timer | Octet 2 |
| Number of IP PDUs to be loop backed at the expiry of 1^{st} timer | Octet 3 |
| . . . | . . . |
| IP PDU delay for N^{th} timer | Octet 2N |
| Number of IP PDUs to be loop backed at the expiry of N^{th} timer | Octet 2N + 1 |

### UE Test Loop Mode X Setup is:

In some example embodiments, the configuration may also indicate, as shown below, the respective one or more delay values are configured in a granularity of milliseconds or less.

TABLE 5

| | | | | | | | | |
|---|---|---|---|---|---|---|---|---|
| 8 | 7 | 6 | 5 | 4 | 3 | 2 | 1 | bit no. |
| T7 | T6 | T5 | T4 | T3 | T2 | T1 | T0 | octet 1 |

### An Example of IP PDU Delay is Show as Below:

### Where T7 . . . . T0=Value of T_Delay_modeB Timer.

It is to be understood that the field “IP PDU delay” can be of any suitable size, e.g., 1 Octet, 2 Octets, or more, which will not be limited by the example as shown in Table 5.

It is noted that the granularity of T_delay_modeB is proposed to be changed in milliseconds. In this way, the delay time of each timer can be configured in the granularity of milliseconds.

Continue to refer to FIG. 2, the first apparatus 110 may perform (206) a test loop based on the configuration. For example, the first apparatus 110 may determine the test loop mode based on the Close UE Test Loop message and perform, for example, UE test loop mode X.

Then, the first apparatus 110 may loop (208) data back to the second apparatus 120 based on the configuration of the test loop mode. Correspondingly, the second apparatus 120 may receive (210) the data looped back.

As mentioned above, the configuration indicates one or more timers for delaying a plurality of PDUs buffered and corresponding amount/number of PDUs to be flushed/looped back at an expiry of each configured timer.

In a case where the timers in the configuration are configured with an independent way within which all timers 301-304 have a same start time point. As shown in FIG. 3, at the end time point of timer 301, the first set of PDUs will start loop backing, and so on until the fourth set of PDUs start loop backing at the end time point of the timer 304. It is to be understood that the number of PDU sets can be less, or equal, or more than 4 in a test. The number of the PDU sets will not be limited by the examples shown in FIGS. 3 and 4.

In a case where the timers in the configuration are configured with dependent way within which timers 401-404 are configured with different start points, as shown in FIG. 4, at the end time point of timer 401, the first set of PDUs will start loop backing. Then the second set of PDUs will start loop backing at the end time point of timer 402 and so on until the fourth set of PDUs start loop backing at the end time point of timer 404.

In this way, the solution of the present disclosure configures multiple IP PDU delay timers and provides more flexible configuration. Furthermore, the solution allows loopback of different data PDUs received on different DRBs with individual delay timer value, i.e., the independent way proposes multiple delay timers to be running in parallel (to be configured in parallel and start simultaneously) whereas the dependent way uses only one timer to provide multiple delays by resetting its value to second IP PDU delay value on expiry of the first and immediately starting the timer again.

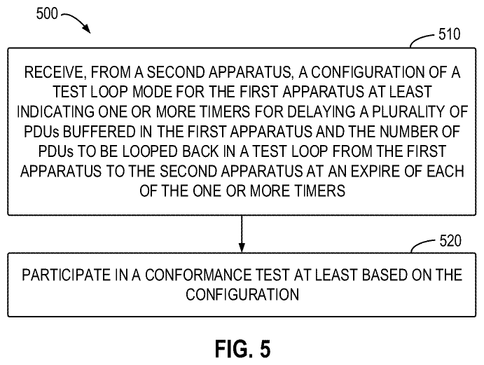

FIG. 5 shows a flowchart of an example method 500 implemented at a first device in accordance with some example embodiments of the present disclosure. For the purpose of discussion, the method 500 will be described from the perspective of the first apparatus 110 in FIG. 1.

At block 510, the first apparatus 110 receives, from a second apparatus, a configuration of a test loop mode for the first apparatus at least indicating one or more timers for delaying a plurality of PDUs, buffered in the first apparatus and the number of PDUs to be looped back in a test loop from the first apparatus to the second apparatus at an expire of each of the one or more timers.

At block 520, the first apparatus 110 participates in the conformance test at least based on the configuration.

In some example embodiments, the method 500 further comprises: the first apparatus 110 receives the configuration from the second apparatus via a Close UE Test Loop message.

In some example embodiments, the Close UE Test Loop message includes an information element indicating the test loop mode.

In some example embodiments, the Close UE Test Loop message includes an information element indicating the configuration, and wherein the configuration further comprises at least one of the following: the number of the one or more timers, respective one or more delay values for the one or more timers, the number of buffered PDUs to be flushed at the expiry of each of the one or more timers in a FIFO, fashion, or a link between respective one or more PDUs and the one or more timers.

In some example embodiments, the respective one or more delay values are configured in a granularity of milliseconds or less.

In some example embodiments, the one or more timers are configured with a same start time point and with different durations.

In some example embodiments, the one or more timers are configured with different start time points and a start time point of a subsequent timer in the one or more timers is relative to an expiry time of a previous timer in the one or more timers.

In some example embodiments, the first apparatus comprises a terminal device and the second apparatus comprises a test equipment or a system simulator.

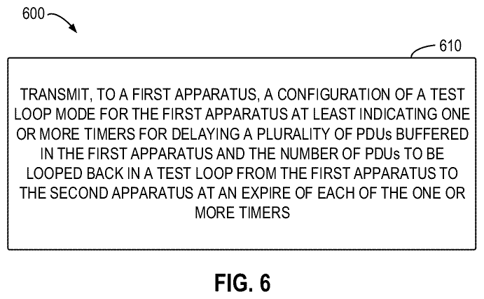

FIG. 6 shows a flowchart of an example method 600 implemented at a second device in accordance with some example embodiments of the present disclosure. For the purpose of discussion, the method 600 will be described from the perspective of the second apparatus 120 in FIG. 1.

At block 610, the second apparatus 120 transmits, to a first apparatus, a configuration of a test loop mode for the first apparatus at least indicating one or more timers for delaying a plurality of PDUs, buffered in the first apparatus and the number of PDUs to be looped back in a test loop from the first apparatus to the second apparatus at an expire of each of the one or more timers.

In some example embodiments, the method 600 further comprises: the second apparatus 120 transmits the configuration to the first apparatus via a Close UE Test Loop message.

In some example embodiments, the Close UE Test Loop message includes an information element indicating the test loop mode.

In some example embodiments, the Close UE Test Loop message includes an information element indicating the configuration, and wherein the configuration further comprises at least one of the following: the number of the one or more timers, respective one or more delay values for the one or more timers, the number of buffered PDUs to be flushed at the expiry of each of the one or more timers in a FIFO, fashion, or a link between respective one or more PDUs and the one or more timers.

In some example embodiments, the respective one or more delay values are configured in a granularity of milliseconds or less.

In some example embodiments, the one or more timers are configured with a same start time point and with different durations.

In some example embodiments, the one or more timers are configured with different start time points and a start time point of a subsequent timer in the one or more timers is relative to an expiry time of a previous timer in the one or more timers.

In some example embodiments, the first apparatus comprises a terminal device and the second apparatus comprises a test equipment or a system simulator.

In some example embodiments, a first apparatus capable of performing any of the method 500 (for example, the first apparatus 110 in FIG. 1) may comprise means for performing the respective operations of the method 500. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus, a configuration of a test loop mode for the first apparatus at least indicating one or more timers for delaying a plurality of PDUs, buffered in the first apparatus and the number of PDUs to be looped back in a test loop from the first apparatus to the second apparatus at an expire of each of the one or more timers; and means for participating in the conformance test at least based on the configuration.

In some example embodiments, the first apparatus further comprises: means for receiving the configuration from the second apparatus via a Close UE Test Loop message.

In some example embodiments, the Close UE Test Loop message includes an information element indicating the test loop mode.

In some example embodiments, the Close UE Test Loop message includes an information element indicating the configuration, and wherein the configuration further comprises at least one of the following: the number of the one or more timers, means for respective one or more delay values for the one or more timers, means for the number of buffered PDUs to be flushed at the expiry of each of the one or more timers in a FIFO, fashion, or a link between respective one or more PDUs and the one or more timers.

In some example embodiments, the respective one or more delay values are configured in a granularity of milliseconds or less.

In some example embodiments, the one or more timers are configured with a same start time point and with different durations.

In some example embodiments, the one or more timers are configured with different start time points and a start time point of a subsequent timer in the one or more timers is relative to an expiry time of a previous timer in the one or more timers.

In some example embodiments, the first apparatus comprises a terminal device and the second apparatus comprises a test equipment or a system simulator.

In some example embodiments, the first apparatus further comprises means for performing other operations in some example embodiments of the method 500 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 600 (for example, the second apparatus 120 in FIG. 1) may comprise means for performing the respective operations of the method 600. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus, a configuration of a test loop mode for the first apparatus at least indicating one or more timers for delaying a plurality of PDUs, buffered in the first apparatus and the number of PDUs to be looped back in a test loop from the first apparatus to the second apparatus at an expire of each of the one or more timers.

In some example embodiments, the second apparatus further comprises: means for transmitting the configuration to the first apparatus via a Close UE Test Loop message.

In some example embodiments, the Close UE Test Loop message includes an information element indicating the test loop mode.

In some example embodiments, the Close UE Test Loop message includes an information element indicating the configuration, and wherein the configuration further comprises at least one of the following: the number of the one or more timers, means for respective one or more delay values for the one or more timers, means for the number of buffered PDUs to be flushed at the expiry of each of the one or more timers in a FIFO, fashion, or a link between respective one or more PDUs and the one or more timers.

In some example embodiments, the respective one or more delay values are configured in a granularity of milliseconds or less.

In some example embodiments, the one or more timers are configured with a same start time point and with different durations.

In some example embodiments, the one or more timers are configured with different start time points and a start time point of a subsequent timer in the one or more timers is relative to an expiry time of a previous timer in the one or more timers.

In some example embodiments, the first apparatus comprises a terminal device and the second apparatus comprises a test equipment or a system simulator.

In some example embodiments, the second apparatus further comprises means for performing other operations in some example embodiments of the method 600 or the second apparatus 120. In some example embodiments, the means comprises at least one processor; and at least one memory storing instructions that, when executed by the at least one processor, cause the performance of the second apparatus.

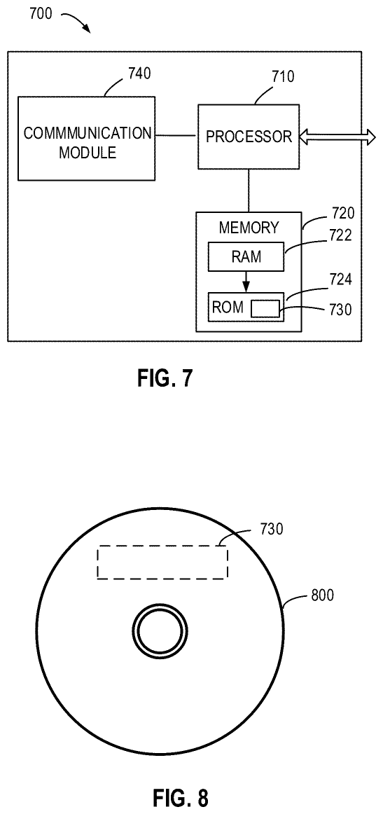

FIG. 7 is a simplified block diagram of a device 700 that is suitable for implementing example embodiments of the present disclosure. The device 700 may be provided to implement a communication device, for example, the first device 110 or the second apparatus 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 2 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first apparatus comprising:
at least one processor; and
at least one memory storing instructions that, when executed by the at least one processor, cause the first apparatus at least to:
receive, from a second apparatus, a configuration of a test loop mode for the first apparatus at least indicating one or more timers for delaying a plurality of protocol data units, PDUs, buffered in the first apparatus and the number of PDUs to be looped back in a test loop from the first apparatus to the second apparatus at an expire of each of the one or more timers; and
participate in a conformance test at least based on the configuration.

2.-20. (canceled)
